(19) United States
(12) Patent Application Publication
(10) Pub. No.: US 2025/0105406 A1
(43) Pub. Date: Mar. 27, 2025

(54) MULTILAYER FILM FOR SECONDARY BATTERY CELL POUCH AND MANUFACTURING METHOD THEREFOR

(71) Applicant: Chan Sik KIM, Gyeongsangbuk-do (KR)

(72) Inventor: Chan Sik KIM, Gyeongsangbuk-do (KR)

(21) Appl. No.: 18/730,669

(22) PCT Filed: Jan. 16, 2023
(86) PCT No.: PCT/KR2023/000714

§ 371 Date: Jul. 19, 2024

(30) Foreign Application Priority Data
Jan. 24, 2022 (KR) 10-2022-0009989

(51) Int. Cl. H01M 50/129; H01M 50/105; H01M 50/119; H01M 50/121

(52) U.S. Cl. CPC H01M 50/129; H01M 50/105; H01M 50/119; H01M 50/121

(57) ABSTRACT

The present invention relates to a multilayer film for a secondary battery cell pouch and a manufacturing method therefor and, specifically, to a multilayer film for a secondary battery cell pouch and a manufacturing method therefor, wherein the multilayer film having excellent film characteristics, such as water resistance, airtightness, chemical resistance, strength, surface tension, electrolysis resistance, and heat resistance, is obtained by simultaneously biaxially stretching a laminate, composed of a plurality of resin layers and adhesive layers, at a time. The multilayer film for a secondary battery cell pouch of the present invention is obtained by simultaneously biaxially stretching a multilayer laminate at a time, the multilayer laminate sequentially comprising an upper resin layer, an intermediate resin layer, a lower resin layer, and adhesive layers formed between the respective resin layers.

### TECHNICAL FIELD

The present invention relates to a multilayer film for a secondary battery cell pouch and a method of manufacturing the same, and more particularly to a multilayer film for a secondary battery cell pouch, which is obtained by simultaneously biaxially stretching a laminate composed of resin layers and tie layers, exhibiting excellent film properties such as water resistance, airtightness, chemical resistance, strength, surface tension, electrolytic resistance, heat resistance, and the like, and a method of manufacturing the same.

### BACKGROUND ART

A secondary battery is capable of repeating charging and discharging, and is configured to include a cathode, an anode, an electrolyte, a separator, and a container. Electricity is generated by the electrical flow of lithium ions moving through the electrolyte between the cathode and the anode.

Secondary batteries are classified into pouch-type secondary batteries, cylindrical secondary batteries, and prismatic secondary batteries, depending on the material of the case that accommodates the electrode assembly. Pouch-type secondary batteries are preferred in view of capacity and safety. A pouch-type secondary battery has a structure in which an electrode assembly is accommodated in a pouch formed with a pouch film made of a soft polymer material.

Accordingly, pouches for secondary batteries using multilayer films have recently been developed. Pouches for secondary batteries must have excellent formability and be capable of thinning and process simplification. Since the pouches contain chemicals inside, they must have the basic properties required for a pouch film such as chemical resistance and electrolytic resistance, moisture resistance and gas barrier properties able to block water vapor and air from the outside, heat dissipation properties, and the like.

Conventional pouch films are made of, for example, polyethylene terephthalate (PET)/nylon/aluminum (Al)/cast polypropylene (CPP), and are manufactured by laminating each film by dry lamination using an adhesive. Specifically, the currently mainly available pouch film is manufactured in the form of 12 μm thick PET (laminated with an adhesive)—15 μm thick nylon (laminated with an adhesive)—40 μm thick aluminum foil (laminated with an adhesive)—80 to 120 μm thick CPP.

The pouch films thus manufactured have the disadvantage of long production time and high production cost.

In particular, today, as the electric vehicle market is growing significantly, the performance, safety, and economic efficiency of vehicle batteries are becoming very important. In addition, cell pouches that package vehicle batteries are also regarded as very important in relation to the safety, performance, and economic efficiency of batteries, and process improvements and improvements in performance, safety, and economic efficiency are required.

### [Citation List]

### PATENT LITERATURE

(Patent Document 1) Korean Patent Application Publication No. 10-2021-0112085
(Patent Document 2) Korean Patent Application Publication No. 10-2021-0017228
(Patent Document 3) Korean Patent Application Publication No. 10-2021-0072322
(Patent Document 4) Korean Patent Application Publication No. 10-2019-0094728
(Patent Document 5) Korean Patent Application Publication No. 10-2020-0017126

### SUMMARY OF THE INVENTION

### Technical Problem

An object of the present invention is to provide a multilayer film for a secondary battery cell pouch with excellent properties such as formability, water resistance, airtightness, chemical resistance, burst fracture strength, sealing strength, surface tension, electrolytic resistance, heat resistance, and the like.

Another object of the present invention is to provide a multilayer film for a secondary battery cell pouch and a method of manufacturing the same, in which a multilayer film including a plurality of film layers and a plurality of tie layers is manufactured by simultaneous biaxial stretching without a dry lamination process, reducing the manufacturing time and cost and achieving economic efficiency.

### Technical Solution

The present invention provides:

a multilayer film for a secondary battery cell pouch obtained by simultaneously biaxially (TD, MD) stretching a multilayer laminate including, sequentially:

an upper resin layer including any one selected from among polypropylene (PP) and polyphenylene ether (PPE);

an intermediate resin layer including any one selected from among polyphenylene ether (PPE) and ethylene vinyl alcohol (EVOH); and a lower resin layer including at least one selected

from among polypropylene (PP), ethylene vinyl alcohol (EVOH), and metallocene linear low-density polyethylene (MLLDPE), and tie layers formed between the resin layers.

In a preferred embodiment, the lower resin layer sequentially includes:

a lower first resin layer including any one selected from among ethylene vinyl alcohol (EVOH) and metallocene linear low-density polyethylene (MLLDPE);

a tie layer; and

a lower second resin layer including at least one selected from among metallocene linear low-density polyethylene (MLLDPE) and polypropylene (PP).

In the multilayer laminate according to a preferred embodiment,

the upper resin layer includes polypropylene (PP),

the intermediate resin layer includes polyphenylene ether (PPE),

the lower first resin layer includes ethylene vinyl alcohol (EVOH), and

the lower second resin layer includes metallocene linear low-density polyethylene (MLLDPE).

In the multilayer laminate according to another preferred embodiment,

the upper resin layer includes polyphenylene ether (PPE),

the intermediate resin layer includes ethylene vinyl alcohol (EVOH),

the lower first resin layer includes metallocene linear low-density polyethylene (MLLDPE), and

the lower second resin layer includes polypropylene (PP).

In addition, the present invention provides:

a multilayer film with an aluminum layer laminated for a secondary battery cell pouch, further including a tie layer and an aluminum layer under the lower resin layer of the multilayer film described above.

The present invention provides a method of manufacturing a multilayer film for a secondary battery cell pouch, including:

manufacturing a multilayer laminate including, sequentially, an upper resin layer including any one selected from among polypropylene (PP) and polyphenylene ether (PPE), an intermediate resin layer including any one selected from among polyphenylene ether (PPE) and ethylene vinyl alcohol (EVOH), and a lower resin layer including at least one selected from among polypropylene (PP), ethylene vinyl alcohol (EVOH), and metallocene linear low-density polyethylene (MLLDPE), and tie layers formed between the resin layers; and

manufacturing a multilayer film by simultaneously biaxially (TD, MD) stretching the multilayer laminate.

In addition, the present invention provides a method of manufacturing a multilayer film with an aluminum layer laminated for a secondary battery cell pouch, including:

multilayer laminate including, manufacturing a sequentially, an upper resin layer including any one selected from among polypropylene (PP) and polyphenylene ether (PPE), an intermediate resin layer including any one selected from among polyphenylene ether (PPE) and ethylene vinyl alcohol (EVOH), and a lower resin layer including at least one selected from among polypropylene (PP), ethylene vinyl alcohol (EVOH), and metallocene linear low-density polyethylene (MLLDPE), and tie layers formed between the resin layers;

manufacturing a multilayer film by simultaneously biaxially (TD, MD) stretching the multilayer laminate; and

laminating an aluminum layer to the lower resin layer of the multilayer film.

As used herein, the term “multilayer film for a secondary battery cell pouch” refers to a multilayer film in which an aluminum layer is not laminated, unless specifically limited.

As used herein, the term “multilayer film with an aluminum layer laminated for a secondary battery cell pouch” refers to a multilayer film including an aluminum layer, unless specifically limited.

The terms or words used in the present specification and claims should not be construed as being limited to the ordinary or dictionary meanings, and should be understood as having meanings and concepts consistent with the technical spirit of the present invention based on the principle that the inventor may appropriately define the concepts of terms in order to explain the invention in the best way.

### Advantageous Effects

According to the present invention, a multilayer film for a secondary battery cell pouch is excellent in formability, water resistance, airtightness, chemical resistance, burst fracture strength, sealing strength, surface tension, electrolytic resistance, and heat resistance, and when applied as a secondary battery cell pouch, performance, safety, and economic efficiency of the battery can be improved.

According to the present invention, a multilayer film with excellent film properties such as airtightness, chemical resistance, electrolytic resistance, strength, and the like can be manufactured by simultaneously biaxially stretching a laminate composed of resin layers and tie layers, greatly reducing the manufacturing time and cost compared to a conventional method of manufacturing a multilayer film including manufacturing each layer film followed by a dry lamination process, and a multilayer film with better properties required as a cell pouch film for a secondary battery can be obtained.

The multilayer film for a secondary battery cell pouch according to the present invention can also be utilized in various end uses such as food packaging, industrial packaging materials, etc., in addition to cell pouches for secondary batteries.

### BRIEF DESCRIPTION OF DRAWINGS

FIG. 1 is a cross-sectional view conceptually showing a multilayer film for a secondary battery cell pouch according to an embodiment of the present invention; and

FIG. 2 is a cross-sectional view conceptually showing a multilayer film for a secondary battery cell pouch according to another embodiment of the present invention.

### DETAILED DESCRIPTION

Hereinafter, a detailed description will be given of preferred embodiments of the present invention with reference to the attached drawings. The preferred embodiments below are merely set forth to illustrate the present invention and are not to be construed as limiting the scope of the present invention thereto.

### Multilayer Film for Secondary Battery Cell Pouch

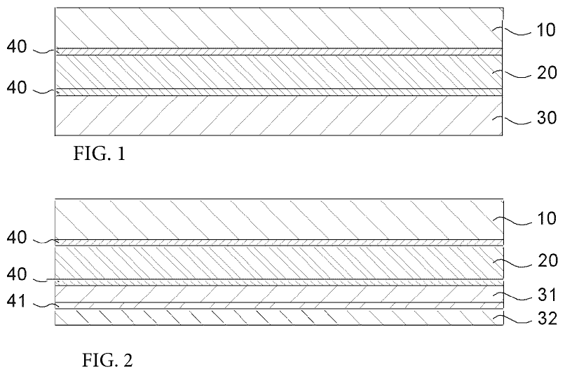

FIG. 1 is a conceptual cross-sectional view of a multilayer film for a secondary battery cell pouch according to an embodiment of the present invention. The multilayer film for a secondary battery cell pouch according to the present invention is obtained by simultaneously biaxially stretching a multilayer laminate including, sequentially, an upper resin layer 10, an intermediate resin layer 20, and a lower resin layer 30, and tie layers 40 formed between the resin layers.

FIG. 2 is a conceptual cross-sectional view of a multilayer film for a secondary battery cell pouch according to another embodiment of the present invention. The upper resin layer 10, the intermediate resin layer 20, and the tie layer 40 are the same as in the embodiment shown in FIG. 1, and the lower resin layer includes two resin layers and a tie layer formed therebetween. The lower resin layer sequentially includes a lower first resin layer 31 including any one selected from among ethylene vinyl alcohol (EVOH) and metallocene linear low-density polyethylene (MLLDPE), a tie layer 41, and a lower second resin layer 32 including at least one selected from among metallocene linear low-density polyethylene (MLLDPE) and polypropylene (PP). The multilayer film is obtained by simultaneously biaxially stretching the entire laminate including the upper resin layer 10, the intermediate resin layer 20, and the tie layer 40, namely a laminate including a total of seven layers composed of four resin layers and three tie layers formed therebetween.

In the multilayer laminate according to a preferred embodiment,

the upper resin layer includes polypropylene (PP),

the intermediate resin layer includes polyphenylene ether (PPE),

the lower first resin layer includes ethylene vinyl alcohol (EVOH), and

the lower second resin layer includes metallocene linear low-density polyethylene (MLLDPE).

In the multilayer laminate according to another preferred embodiment,

the upper resin layer includes polyphenylene ether (PPE),

the intermediate resin layer includes ethylene vinyl alcohol (EVOH),

the lower first resin layer includes metallocene linear low-density polyethylene (MLLDPE), and

the lower second resin layer includes polypropylene (PP).

Individual layers are described in detail below.

### (1) Upper Resin Layer

The upper resin layer 10 includes any one selected from among polypropylene (PP) and polyphenylene ether (PPE). Polypropylene (PP) and polyphenylene ether (PPE) may be used alone to form the upper resin layer, may be mixed together to form the upper resin layer, or may be mixed with other resins to form the upper resin layer.

In one embodiment, the upper resin layer 10 is made of polypropylene (PP) resin.

In another embodiment, the upper resin layer 10 is made of polyphenylene ether (PPE) resin.

In still another embodiment, the upper resin layer is made of a mixed resin of polypropylene (PP) and metallocene linear low-density polyethylene (MLLDPE). As such, preferably, polypropylene (PP) and metallocene linear low-density polyethylene (MLLDPE) are mixed in a weight ratio of 10-90:10-90. More preferably, polypropylene (PP) and metallocene linear low-density polyethylene (MLLDPE) are mixed in a weight ratio of 10-30:70-90.

The upper resin layer is the outermost surface layer and is regarded as important for thermal adhesion of a cell pouch.

Polypropylene (PP) constituting the upper resin layer is preferably composed of 50 to 90 wt % of commonly useful homopolypropylene and 10 to 50 wt of random polypropylene, in order to increase thermal adhesion of a cell pouch. Random polypropylene results from adding a small amount of ethylene during polypropylene polymerization, and d is commercialized. Polypropylene, composed of a mixture of homopolypropylene and random polypropylene, serves to improve strength and flexibility and to enhance thermal adhesion.

The upper resin layer 10 preferably further includes 3 to 10 wt % of a silicone fluorine elastomer (fluorosilicone rubber) based on the weight of the resin constituting the layer, in order to improve film properties as a cell pouch, such as strength, flexibility, airtightness, etc.

When the upper resin layer includes polyphenylene ether (PPE), it preferably further includes 5 to 30 wt % of glass fiber based on the amount of polyphenylene ether (PPE), in order to improve properties such as strength, etc.

The thickness of the upper resin layer 10 is not limited, but is preferably about 40 to 120 μm, more preferably about 60 to 100 μm.

### (2) Intermediate Resin Layer

The intermediate resin layer 20 includes any one selected from among polyphenylene ether (PPE) and ethylene vinyl alcohol (EVOH). Polyphenylene ether (PPE) and ethylene vinyl alcohol (EVOH) may be used alone to form the intermediate resin layer, may be mixed together to form the intermediate resin layer, or may be mixed with other resins to form the intermediate resin layer.

In one embodiment, the intermediate resin layer 20 is made of polyphenylene ether (PPE) resin.

In another embodiment, the intermediate resin layer 20 is made of ethylene vinyl alcohol (EVOH) resin. In the intermediate resin layer 20, ethylene vinyl alcohol (EVOH) may serve as a barrier that prevents leaching of harmful substances.

When the intermediate resin layer includes polyphenylene ether (PPE), it preferably further includes 5 to 30 wt % of glass fiber based on the amount of polyphenylene ether (PPE), in order to improve properties such as strength, etc.

The thickness of the intermediate resin layer 20 is not limited, but is preferably about 15 to 30 μm.

### (3) Lower Resin Layer

The lower resin layer 30 includes at least one selected from among polypropylene (PP), ethylene vinyl alcohol (EVOH), and metallocene linear low-density polyethylene (MLLDPE). Polypropylene (PP), ethylene vinyl alcohol (EVOH), and metallocene linear low-density polyethylene (MLLDPE) may be used alone to form the lower resin layer, may be mixed together to form the lower resin layer, or may be mixed with other resins to form the lower resin layer.

In one embodiment, the lower resin layer 30 is made of polypropylene (PP) resin. As such, polypropylene (PP) is preferably used by mixing 50 to 90 wt % of homopolypropylene and 10 to 50 wt % of random polypropylene. A specific description of polypropylene (PP) is the same as in the upper resin layer.

In another embodiment, the lower resin layer 30 is made of ethylene vinyl alcohol (EVOH) resin. As such, ethylene vinyl alcohol (EVOH) constituting the lower resin layer 30 may serve as a barrier that prevents leaching of harmful substances.

In still another embodiment, the lower resin layer 30 is made of metallocene linear low-density polyethylene (MLLDPE) resin.

In yet another embodiment, the lower resin layer 30 is made of a mixed resin of polypropylene (PP) and metallocene linear low-density polyethylene (MLLDPE). As such, polypropylene (PP) and metallocene linear low-density polyethylene (MLLDPE) are preferably mixed in a weight ratio of 10-90:10-90. More preferably, polypropylene (PP) and metallocene linear low-density polyethylene (MLLDPE) are mixed in a weight ratio of 40-80:20-60.

The lower resin layer preferably further includes 3 to 10 wt % of a silicone fluorine elastomer (fluorosilicone rubber) based on the weight of the resin constituting the layer, in order to improve film properties as a cell pouch, such as strength, flexibility, airtightness, etc.

In a preferred embodiment, the lower resin layer 30 is composed of two resin layers, namely a lower first resin layer 31 and a lower second resin layer 2, with a tie layer 41 interposed therebetween, as shown in FIG. 2. Each layer is described below.

(a) Lower first resin layer 31

The lower first resin layer 31 includes any one selected from among ethylene vinyl alcohol (EVOH) and metallocene linear low-density polyethylene (MLLDPE). Ethylene vinyl alcohol (EVOH) and metallocene linear low-density polyethylene (MLLDPE) may be used alone to form the lower first resin layer, may be mixed together to form the lower first resin layer, or may be mixed with other resins to form the lower first resin layer.

In one embodiment, the lower first resin layer is made of ethylene vinyl alcohol (EVOH) resin.

In another embodiment, the lower first resin layer is made of metallocene linear low-density polyethylene (MLLDPE) resin.

The thickness of the lower first resin layer is not limited, but is preferably about 5 to 20 μm.

A description of each resin is the same as in the lower resin layer 30 above.

(b) Lower second resin layer 32

The lower second resin layer 32 includes any one selected from among metallocene linear low-density polyethylene (MLLDPE) and polypropylene (PP). Metallocene linear low-density polyethylene (MLLDPE) and polypropylene (PP) may be used alone to form the lower second resin layer, may be mixed together to form the lower second resin layer, or may be mixed with other resins to form the lower second resin layer.

In one embodiment, the lower second resin layer is made of metallocene linear low-density polyethylene (MLLDPE) resin.

In another embodiment, the lower second resin layer is made of polypropylene (PP) resin.

In still another embodiment, the lower second resin layer is made of a mixed resin of polypropylene (PP) and metallocene linear low-density polyethylene (MLLDPE).

A description of each resin and mixed resin is the same as in the lower resin layer 30 above.

The thickness of the lower second resin layer is not limited, but is preferably about 20 to 40 μm.

The lower second resin layer preferably further includes 3 to 10 wt % of a silicone fluorine elastomer (fluorosilicone rubber) based on the weight of the resin constituting the layer, in order to improve film properties as a cell pouch, such as strength, flexibility, airtightness, etc.

### (4) Tie Layer

The tie layer 40 is formed between the resin layers as shown in FIG. 1. As shown in FIG. 2, the tie layer 41 may also be formed between the lower first resin layer and the lower second resin layer. The tie layer may be formed by applying a general adhesive. However, the tie layer preferably includes a silicone fluorine elastomer (fluorosilicone rubber). When the tie layer includes a silicone fluorine elastomer in this way, conductivity resistance and electrolytic resistance may be greatly improved. Preferably, the tie layer includes 5 to 70 wt % of a silicone fluorine elastomer. The tie layer particularly preferably includes 10 to 60 wt % of a silicone fluorine elastomer, 10 to 60 wt % of a polyolefin-type curing agent, and 5 to 30 wt % of an epoxy-type curing agent.

Multilayer Film with Aluminum Layer Laminated for Secondary Battery Cell Pouch

A tie layer is formed on the bottom surface of the lower resin layer 30 or the lower second resin layer 32, which is the bottom of the multilayer film for a secondary battery cell pouch, and an aluminum layer is laminated thereon, thereby obtaining a multilayer film with an aluminum layer laminated for a secondary battery cell pouch.

A description of the tie layer is the same as above.

For the aluminum layer, aluminum, which is generally applied to multilayer films for secondary battery cell pouches, may be used. The thickness of the aluminum layer is not limited, but is generally preferably about 30 to 50 μm.

### Manufacture of Multilayer Film for Secondary Battery Cell Pouch

A method of manufacturing a multilayer film for a secondary battery cell pouch includes manufacturing a multilayer laminate including resin layers and tie layers formed therebetween as described above, and

manufacturing a multilayer film by simultaneously biaxially (TD, MD) stretching the multilayer laminate.

A method of manufacturing a multilayer film with an aluminum layer laminated for a secondary battery cell pouch further includes laminating an aluminum layer to the lower resin layer of the manufactured multilayer film.

As described above, a multilayer resin laminate of the present invention, including at least five layers including at least three resin layers and two tie layers formed therebetween, or at least seven layers including at least four resin layers and three tie layers formed therebetween, may be subjected to simultaneous biaxial stretching. In the present invention, time and cost may be saved by simultaneously biaxially stretching a multilayer resin laminate including at least five layers or at least seven layers, and it is possible to obtain a multilayer film with better properties required as a cell pouch film for secondary batteries, such as formability, water resistance, airtightness, surface tension, sealing strength, electrolytic resistance sealing strength, heat resistance, etc.

The multilayer film obtained according to the present invention has excellent film properties and may thus be utilized in various end uses such as food packaging, industrial packaging materials, etc., in addition to cell pouches for secondary batteries.

A better understanding of the present invention may be obtained through the following examples. These examples are merely set forth to illustrate the present invention, and are not to be construed as limiting the scope of the present invention.

### Example 1

An 80 μm thick polypropylene resin layer was formed using a mixture of 70 wt % of homopolypropylene and 30 wts of random polypropylene.

A tie layer 1 was formed on the polypropylene resin layer using a mixture of 45 wt % of a silicone fluorine elastomer, 40 wt % of a polyolefin-type curing agent, and 15 wt % of an epoxy-type curing agent.

A 15 μm thick polyphenylene ether (PPE) resin layer was formed on the tie layer 1 using polyphenylene ether (PPE) including 20 wt % of glass fiber.

A tie layer 2 was formed on the polyphenylene ether (PPE) resin layer in the same manner as in the tie layer 1.

A 10 μm thick ethylene vinyl alcohol (EVOH) resin layer was formed on the tie layer 2.

A tie layer 3 was formed on the ethylene vinyl alcohol (EVOH) resin layer in the same manner as in the tie layer 1.

A 30 μm thick mixed resin layer was formed on the tie layer 3 using a mixture of 60 wt % of metallocene linear low-density polyethylene (MLLDPE), 30 wt % of polypropylene (PP), and 10 wt % of silicone fluorine elastomer.

A multilayer film for a secondary battery cell pouch (hereinafter referred to as a “multilayer film”) was obtained by simultaneously biaxially (TD, MD) stretching the multilayer laminate including a total of seven layers formed as described above.

### Example 2

A multilayer film with an aluminum layer laminated for a secondary battery cell pouch was obtained by forming a tie layer 4 in the same manner as in the tie layer 1 on the bottom surface of the mixed resin layer of the multilayer film obtained in Example 1 and laminating a 40 μm thick aluminum layer thereon.

### Example 3

An 80 μm thick polypropylene (PP) resin layer was formed by mixing a polypropylene mixture of 70 wt % of homopolypropylene and 30 wt % of random polypropylene with metallocene linear low-density polyethylene (MLLDPE) in a weight ratio of 20:80 and adding 10 wt % of a silicone fluorine elastomer thereto.

A tie layer 1 was formed on the polypropylene (PP) resin layer using a mixture of 45 wt % of a silicone fluorine elastomer, 40 wt % of a polyolefin-type curing agent, and 15 wt % of an epoxy-type curing agent.

A 15 μm thick polyphenylene ether (PPE) resin layer was formed on the tie layer 1 using polyphenylene ether (PPE) including 20 wt % of glass fiber.

A tie layer 2 was formed on the polyphenylene ether (PPE) resin layer in the same manner as in the tie layer 1.

A 10 μm thick ethylene vinyl alcohol (EVOH) resin layer was formed on the tie layer 2.

A tie layer 3 was formed on the ethylene vinyl alcohol (EVOH) resin layer in the same manner as in the tie layer 1.

A 30 μm thick resin layer was formed on the tie layer 3 using a mixed resin including 60 wt % of metallocene linear low-density polyethylene (MLLDPE), 30 wt % of polypropylene (PP), and 10 wt % of silicone fluorine elastomer.

A multilayer film (“multilayer film for a secondary battery cell pouch”) was obtained by simultaneously biaxially (TD, MD) stretching the multilayer laminate including a total of seven layers formed as described above.

### Example 4

A multilayer film with an aluminum layer laminated for a secondary battery cell pouch was obtained by forming a tie layer 4 in the same manner as in the tie layer 1 on the bottom surface of the mixed resin layer of the multilayer film obtained in Example 3 and laminating a 40 μm thick aluminum layer thereon.

### Test Example 1

The performance of the multilayer film for a secondary battery cell pouch according to the present invention was confirmed as follows. As a sample, the multilayer film for a secondary battery cell pouch obtained in Example 1, namely a multilayer film without aluminum laminated (hereinafter referred to as a “multilayer film”) was used. The sample of Comparative Example 1 used was a cell pouch film with aluminum laminated available from DNP, Japan (hereinafter referred to as a “DNP cell pouch film” or “cell pouch film”).

Performance was confirmed in view of formability, water resistance, sealing strength, and surface tension.

Formability was determined by loading the multilayer film of Example 1 and the cell pouch film sample of Comparative Example 1 into a pouch film molding machine, followed by molding at a speed of 5 m/min and a (pneumatic) pressure of 5 gf/cm2 and then measurement of changes in depth of the film.

Water resistance was determined by visually observing the multilayer film of Example 1 and the cell pouch film of Comparative Example 1 after immersion in distilled water at 86° C. for 7 days and then drying. Surface tension was measured using a Dyne Pen.

In the second to seventh tests after the first test, the multilayer film of Example 1 and the cell pouch film of Comparative Example 1 were repeatedly tested and compared after immersion.

The results thereof are shown in Table 1 below.

TABLE 1

| | | Performance indicator | | | |
|---|---|---|---|---|---|
| | | (aging state after lamination) | | | |
| | | | Water resis- | | |
| | | | tance of | Sealing | Surface |
| | | Formability | outer layer | strength | tension |
| | Sample | (mm) | (visual) | (N/15 mm) | (Dyne) |
| 1^{st} | Example 1 | 8.90 | Good | 145.3 | 42.0 |
| test | Comparative | 8.60 | Good | 140.4 | 38.0 |
| | Example 1 | | | | |
| 2^{nd} | Example 1 | 8.92 | Good | 145.0 | 42.0 |
| test | Comparative | 8.66 | Good | 140.5 | 38.0 |
| | Example 1 | | | | |
| 3^{rd} | Example 1 | 8.99 | Good | 145.3 | 42.0 |
| test | Comparative | 8.72 | Good | 140.3 | 38.0 |
| | Example 1 | | | | |
| 4^{th} | Example 1 | 8.97 | Good | 145.2 | 42.0 |
| test | Comparative | 8.80 | Good | 140.2 | 38.0 |
| | Example 1 | | | | |
| 5^{th} | Example 1 | 8.91 | Good | 145.3 | 41.65 |
| test | Comparative | 8.52 | Good | 140.3 | 38.0 |
| | Example 1 | | | | |
| 6^{th} | Example 1 | 8.96 | Good | 145.3 | 41.8 |
| test | Comparative | 8.55 | Good | 140.3 | 38.0 |
| | Example 1 | | | | |
| 7^{th} | Example 1 | 8.96 | Good | 145.3 | 41.8 |
| test | Comparative | 8.70 | Good | 140.3 | 38.0 |
| | Example 1 | | | | |

As is apparent from the results in Table 1, the multilayer film of the present invention exhibited superior formability, sealing strength, and surface tension compared to the DNP cell pouch film of Comparative Example 1.

### Test Example 2

The performance of the multilayer film for a secondary battery cell pouch according to the present invention was confirmed as follows.

As a sample, the cell pouch film with an aluminum layer laminated obtained in Example 2 was used (hereinafter referred to as a “cell pouch film”). The sample of Comparative Example 2 used was a cell pouch film (PET/NYLON/AL/CPP) laminated using a CPP film available from Okamoto, Japan (hereinafter referred to as an “Okamoto cell pouch film” or a “cell pouch film”).

The performance of the film was confirmed in view of sealing strength before immersion, electrolytic resistance sealing strength after immersion, and slip.

The sealing strength of the cell pouch film of Example 2 and the cell pouch film of Comparative Example 2 was measured every day at 120° C. for 7 days after aging the pouch film and before immersing the same in an electrolyte solution. The test conditions were 15 mm in width and 100 mm/min in speed.

For electrolytic resistance sealing strength, electrolytic resistance was determined by measuring sealing strength of Example 2 and Comparative Example 2 every day for 7 days after immersing the cell pouch film of Example 2 and the cell pouch film of Comparative Example 2 in an electrolyte solution prepared by mixing EC (ethylene carbonate), DMC (dimethyl carbonate), and DEC (diethyl carbonate) as carbonate solvents in a weight ratio of 1:1:1 and adding 1 mol of LiPF₆ (lithium hexafluorophosphate). The test conditions were 15 mm in width and 100 mm/min in speed.

The results thereof are shown in Table 2 below.

TABLE 2

| | | Performance indicator | | |
|---|---|---|---|---|
| | | (aging state after lamination) | | |
| | | | Electrolytic resistance | |
| | | Sealing strength | sealing strength | |
| | | before immersion | after immersion | |
| | Sample | (N/15 mm) | (N/15 mm) | Slip |
| 1^{st} | Example 2 | 15.5 | 21.2 | 0.10 |
| day | Comparative | 15.0 | 20.0 | 0.10 |
| | Example 2 | | | |
| 2^{nd} | Example 2 | 15.8 | 21.0 | 0.10 |
| day | Comparative | 15.5 | 19.5 | 0.10 |
| | Example 2 | | | |
| 3^{rd} | Example 2 | 16.8 | 20.1 | 0.10 |
| day | Comparative | 16.0 | 19.1 | 0.10 |
| | Example 2 | | | |
| 4^{th} | Example 2 | 18.1 | 19.7 | 0.10 |
| day | Comparative | 17.8 | 18.7 | 0.10 |
| | Example 2 | | | |
| 5^{th} | Example 2 | 19.5 | 19.2 | 0.10 |
| day | Comparative | 18.9 | 18.3 | 0.10 |
| | Example 2 | | | |
| 6^{th} | Example 2 | 20.6 | 19.0 | 0.10 |
| day | Comparative | 19.7 | 17.9 | 0.10 |
| | Example 2 | | | |
| 7^{th} | Example 2 | 21.5 | 19.0 | 0.10 |
| day | Comparative | 19.6 | 17.9 | 0.10 |
| | Example 2 | | | |

As is apparent from the results in Table 2, the cell pouch film of the present invention exhibited superior sealing strength and electrolytic resistance sealing strength compared to the Okamoto cell pouch film of Comparative Example 2.

In addition, before immersion in the electrolyte solution, sealing strength increased as time passed after the aging process, and after immersion in the electrolyte solution, sealing strength decreased as the immersion time in the electrolyte solution became longer, but sealing strength was confirmed to be vastly superior.

The multilayer film for a secondary battery cell pouch according to the present invention and the method of manufacturing the same as described above are exemplary, and various modifications and other equivalent embodiments can be made by those skilled in the art. Therefore, it will be understood that the present invention is not limited to the forms mentioned in the detailed description above. Accordingly, the true scope of technical protection of the present invention should be determined by the technical spirit of the appended claims. In addition, it is to be understood that the present invention includes all modifications, equivalents, and substitutions within the spirit and scope of the present invention as defined by the appended claims.

1. A multilayer film for a secondary battery cell pouch obtained by simultaneously biaxially (TD, MD) stretching a multilayer laminate comprising, sequentially:
an upper resin layer comprising any one selected from among polypropylene (PP) and polyphenylene ether (PPE);
an intermediate resin layer comprising any one selected from among polyphenylene ether (PPE) and ethylene vinyl alcohol (EVOH); and
a lower resin layer comprising at least one selected from among polypropylene (PP), ethylene vinyl alcohol (EVOH), and metallocene linear low-density polyethylene (MLLDPE), and
tie layers formed between the resin layers.

2. The multilayer film according to claim 1, wherein the lower resin layer sequentially comprises:
a lower first resin layer comprising any one selected from among ethylene vinyl alcohol (EVOH) and metallocene linear low-density polyethylene (MLLDPE);
a tie layer; and
a lower second resin layer comprising at least one selected from among metallocene linear low-density polyethylene (MLLDPE) and polypropylene (PP).

3. The multilayer film according to claim 2, wherein:
the upper resin layer comprises polypropylene (PP),
the intermediate resin layer comprises polyphenylene ether (PPE),
the lower first resin layer comprises ethylene vinyl alcohol (EVOH), and
the lower second resin layer comprises metallocene linear low-density polyethylene (MLLDPE).

4. The multilayer film according to claim 2, wherein:
the upper resin layer comprises polyphenylene ether (PPE),
the intermediate resin layer comprises ethylene vinyl alcohol (EVOH),
the lower first resin layer comprises metallocene linear low-density polyethylene (MLLDPE), and
the lower second resin layer comprises polypropylene (PP).

5. The multilayer film according to claim 1, wherein the polypropylene (PP) comprises 50 to 90 wt % of homopolypropylene and 10 to 50 wt % of random polypropylene.

6. The multilayer film according to claim 1, wherein the upper resin layer further comprises metallocene linear low-density polyethylene (MLLDPE) in addition to polypropylene (PP).

7. The multilayer film according to claim 1, wherein the lower resin layer or the lower second resin layer comprises polypropylene (PP) and metallocene linear low-density polyethylene (MLLDPE).

8. The multilayer film according to claim 6, wherein the upper resin layer comprises polypropylene (PP) and metallocene linear low-density polyethylene (MLLDPE) in a weight ratio of 10-30:70-90.

9. The multilayer film according to claim 7, wherein the lower resin layer or the lower second resin layer comprises polypropylene (PP) and metallocene linear low-density polyethylene (MLLDPE) in a weight ratio of 40-80:20-60.

10. The multilayer film according to claim 1, wherein at least one selected from among the upper resin layer, the lower resin layer, and the lower second resin layer further comprises 3 to 10 wt % of a silicone fluorine elastomer based on a weight of the resin constituting the layer.

11. The multilayer film according to claim 1, further comprising 5 to 30 wt % of glass fiber based on an amount of the polyphenylene ether (PPE) when comprising the polyphenylene ether (PPE).

12. The multilayer film according to claim 1, wherein the tie layer comprises 10 to 60 wt % of fluorosilicone rubber, 10 to 60 wt % of a polyolefin-type adhesive, and 5 to 30 wt % of an epoxy-type curing agent.

13. A multilayer film with an aluminum layer laminated for a secondary battery cell pouch, further comprising a tie layer and an aluminum layer under the lower resin layer of the multilayer film according to claim 1.

14. A method of manufacturing a multilayer film for a secondary battery cell pouch, comprising:
manufacturing a multilayer laminate comprising, sequentially, an upper resin layer comprising any one selected from among polypropylene (PP) and polyphenylene ether (PPE), an intermediate resin layer comprising any one selected from among polyphenylene ether (PPE) and ethylene vinyl alcohol (EVOH), and a lower resin layer comprising at least one selected from among polypropylene (PP), ethylene vinyl alcohol (EVOH), and metallocene linear low-density polyethylene (MLLDPE), and tie layers formed between the resin layers; and
manufacturing a multilayer film by simultaneously biaxially (TD, MD) stretching the multilayer laminate.

15. A method of manufacturing a multilayer film with an aluminum layer laminated for a secondary battery cell pouch, comprising:
manufacturing a multilayer laminate comprising, sequentially, an upper resin layer comprising any one selected from among polypropylene (PP) and polyphenylene ether (PPE), an intermediate resin layer comprising any one selected from among polyphenylene ether (PPE) and ethylene vinyl alcohol (EVOH), and a lower resin layer comprising at least one selected from among polypropylene (PP), ethylene vinyl alcohol (EVOH), and metallocene linear low-density polyethylene (MLLDPE), and tie layers formed between the resin layers;
manufacturing a multilayer film by simultaneously biaxially (TD, MD) stretching the multilayer laminate; and
laminating an aluminum layer to the lower resin layer of the multilayer film.
